(19) United States
(12) Patent Application Publication
(10) Pub. No.: US 2011/0140927 A1
(43) Pub. Date: Jun. 16, 2011

(54) METHOD AND APPARATUS FOR AVOIDING PARKING VIOLATIONS

(76) Inventor: Kevin Lawrence Lee, Los Angeles, CA (US)

(21) Appl. No.: 12/637,679

(22) Filed: Dec. 14, 2009

(51) Int. Cl. G08G 1/123

(52) U.S. Cl. 340/993

(57) ABSTRACT

The driver of a parked vehicle receives a warning message if the vehicle is parked in violation of parking restrictions. In one aspect, the driver belongs to an organization that monitors vehicles parked in restricted areas. When an informant observes a vehicle parked in violation of parking restrictions, the informant transmits location and vehicle identification information to a central server. The server sends a notification to the member if the vehicle is parked illegally. In another aspect, location information is automatically transmitted to the server when loss of a wireless connection between the vehicle and the driver's communication device indicates the vehicle is in a parked condition. In another aspect, the driver transmits location information to the server before leaving a parked vehicle. The rules and restrictions applicable to the vehicle's location are then sent to the driver's communication device.

### BACKGROUND OF THE INVENTION

1.Field of the Invention

The present invention relates generally to the field of vehicle parking indicators and, more particularly, to a method and apparatus for assisting drivers to park responsibly and to honor posted parking rules and regulations.

2. Background

Vehicle parking on streets and roads is subject to numerous restrictions. In commercial districts, metered parking is common. In some areas, parking is strictly prohibited for safety considerations or to maximize traffic flow. In areas where parking is permissible, whether or not metered, there may be restrictions on when and for how long a vehicle may be parked. Such restrictions are generally posted on signs near the parking areas. Oftentimes, the signs may be obscured by vegetation, may be defaced or may be missing entirely from a particular location. More significantly, even when clearly posted, the restrictions may be complex, making the signs difficult to read and understand.

Whether as a result of poor signage or simple inattention, drivers may inadvertently park their vehicles in violation of parking restrictions. This, of course, frustrates the purpose of the parking restrictions and may result in an expensive citation for the driver.

U.S. Pat. No. 6,133,855 issued to Kim discloses an apparatus and method for warning of illegal stopping and parking of a vehicle. The vehicle is equipped with a global positioning system (GPS) receiver that determines the current position of the car. The running state of the vehicle is determined based on inputs from an engine revolution sensor and a vehicle speed sensor. A data storage unit stores information identifying areas in which parking is prohibited. If the vehicle is detected to be stopped in a prohibited area, a warning is generated.

Kim's invention is directed to solving the problem of “signposts or marking posts not being properly installed and not easy to recognize while driving.” However, a more significant problem is the confusion and difficulty drivers have in reading and interpreting parking signs, which are often posted with a multitude of different restrictions and regulations.

### SUMMARY OF THE INVENTION

The present invention provides several improvements over the system disclosed by Kim. In one aspect, the present invention provides a method and apparatus for issuing a warning to the driver of a parked vehicle that is in violation of parking restrictions even when the vehicle is not equipped with a position-sensing device. The vehicle driver registers with an organization or community that monitors vehicles parked in restricted areas. When a vehicle parked in violation of parking restrictions is observed, a vehicle identification number, such as the vehicle license plate number, tag number or other unique identifier, is transmitted to a central server by an informant. The server, upon verification of the infraction, matches the vehicle identification with membership information and sends a notification to the member of the observed parking violation.

In another aspect, the present invention provides an improved method and apparatus for determining whether a vehicle is parked or not, as well as a new method and apparatus for determining its specific street side location and orientation. Utilizing a two-way communication system between a vehicle and the driver's wireless device such as Bluetooth™ or WiFi, the parking status of a vehicle as well as its specific street side location and orientation can be determined. In the case of Bluetooth™ technology, connectivity depends on both devices being within a certain proximity to each other and also both devices being in a powered-on state. A Bluetooth™ connection is broken either when the distance between the two devices exceeds a certain range (in most cases 30 feet) or when one or both devices are powered off. Therefore, the vehicle can be determined to be in a parked condition when the wireless connection between the vehicle and the driver's communication device has been broken for a certain length of time. Additionally, there are a number of other ways the vehicle can communicate its parked status to the driver's wireless device. For example, when the vehicle is manually turned off by the driver, the vehicle can be programmed to immediately send information regarding this event to the driver's wireless device. Regardless of how this information is sent to the wireless device, when the vehicle is determined to be in a parked condition, the driver's wireless device automatically initiates contact with the central server, transmitting last known GPS coordinates of the vehicle at the time the Bluetooth™ or WiFi link was last connected. GPS coordinates of the vehicle can be obtained from either the vehicle's onboard GPS system or the GPS system in the wireless device. Furthermore, specific street side location information of the vehicle may also be calculated and sent to the central server. If a comparison of the position of the parked vehicle to a database of parking restrictions shows that the vehicle is parked illegally, a warning is then transmitted to the driver's communication device.

In another aspect, the present invention provides a proactive preventative approach in the form of an information service to drivers regarding parking rules and restrictions for a specified location. When a vehicle is in a parked state, the driver transmits location information to a central server using a GPS-equipped wireless device or the vehicle's onboard communication system such as On-Star™. Vehicle location information can also be automatically sent to the central server without initiation from the driver. This would be done through a dedicated software application on the mobile device that runs in the device's background. Information sent to the central server would include GPS coordinates and specific street side location data and orientation of the vehicle. The vehicle's location information is then used to query a database of parking rules and restrictions. Furthermore, if the driver is a registered member of the service, information regarding any special parking permits or exemption permits the driver may have on file are also taken into account. A simple message is then sent to the driver stating only those parking rules and restrictions that are specifically applicable to the vehicle's location and time and day of parking. By paring back all inapplicable parking rules, this simplified message to the driver not only reduces confusion in attempting to interpret multiple parking restrictions but also saves the driver time and effort in reading and interpreting multiple parking signs. Messages are sent preferably in the form of an automated voice response, but can also be in the form of a text message or e-mail message. The message may also include information about nearby alternative parking locations.

### BRIEF DESCRIPTION OF THE DRAWINGS

FIG. 1 is a flow diagram for implementing one embodiment of the present invention.

FIG. 2 is a flow diagram for implementing another embodiment of the present invention.

FIG. 3 is a flow diagram for implementing yet another embodiment of the present invention.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

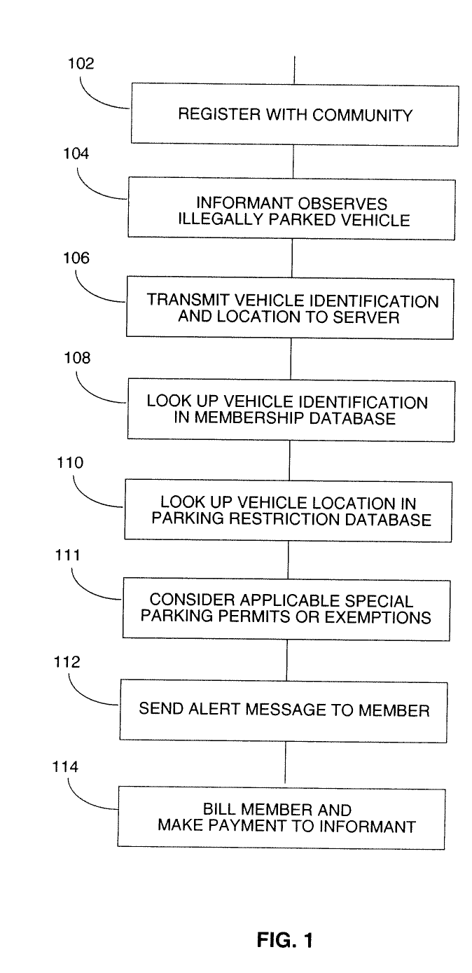

FIG. 1 is a flow diagram for implementing one embodiment of the present invention. In this embodiment, drivers register with a parking monitoring community at step 102, which may be conveniently done at a website maintained by the community organization. The registration process requires registrants to provide information that will be maintained in the community's database. Such information may include, for example, the registrant's name and address, cell phone number, email address, the make, model, year and color of the registrant's vehicle and the vehicle's license number. The registrant may also be required to provide further information related to parking privileges, such as special parking permits (e.g., disabled parking permits, commercial parking permits or other permits) that may exempt the registrant's vehicle from certain parking restrictions.

At the time of registration, the registrant may also be required to provide billing information, such as a credit card account number, for fees to support the community organization. Membership fees may be collected periodically and/or fees may be assessed for each time a parking alert is issued to the registrant. Fees assessed in the latter manner motivate registrants to remain conscientious in abiding by posted parking rules and restrictions.

At step 104, a parked vehicle is observed by an informant, who may be a registered member of the community, a local resident or simply a passerby. The informant may suspect that the vehicle has been parked in violation of the applicable parking rules and restrictions, although, as explained below, it is not strictly necessary for the informant to know the rules and restrictions.

At step 106, the informant, while physically located next to the parked vehicle, contacts the community's server using a GPS-enabled wireless device. Communication with the server may be established in one of several ways (with dedicated software on the informant's mobile device, e.g., an app that the informant has downloaded, or by using a mobile Internet browser, or by voice communication with the server). The informant then sends identification information of the parked vehicle to the server. The identification information may be the vehicle's license plate number or may be the vehicle owner's membership/registration number for the community. In this regard, the community may issue placards, bumper stickers or the like to registered members to be placed on their vehicles. These serve to identify the vehicle as belonging to a registered member and may be imprinted with a unique registration number. In this way, informants have visual evidence that an observed illegally parked vehicle belongs to a member of the community. Along with the vehicle identification information, the informant's wireless device also sends the informant's position information to the server, assuming it is GPS enabled. Since the informant is located within a few feet of the illegally parked vehicle, the informant's position information also provides the vehicle location. Due to limitations of current GPS technology, most GPS devices are accurate to within 3 to 10 meters, meaning a single GPS reading could place the subject vehicle on either side of the street. This presents the possibility of issuing an alert message incorrectly since different parking restrictions may apply on one side of the street versus the other. In order to resolve any ambiguity concerning which side of the street the vehicle is parked on and to eliminate the possibility of sending a false alert, more specific location data can be determined using a wireless device equipped with a compass. If the informant's device is so equipped, the informant activates the compass mode and holds the device facing up and points the device in the direction of travel for the side of the street on which the vehicle is parked (i.e., pointing in the same direction as the front of the vehicle in most cases). The directional information is then also sent to the community server. If the informant's wireless device is not equipped to do this automatically, manual input of the direction information may be necessary. Likewise, if the informant's wireless device is not GPS equipped, manual input to the server is also an option.

An alternative method of sending location information of the illegally parked vehicle to the community server via an informant's wireless device is through a geo-tagged photograph. Assuming the informant's wireless device is equipped with GPS, camera, compass and geo-tagging capabilities, the informant essentially takes a rear and/or front view photograph of the illegally parked vehicle. That image is then sent to the community server, which deciphers the license plate number through optical character recognition (OCR) to identify which member the vehicle belongs to. Because geo-tagged photographs provide verifiable detailed proof that the vehicle is in violation of a parking code, the warning to the driver can also include the geo-tagged image of the vehicle as evidence of the infraction.

Continuing to step 108, the vehicle identification information is matched in the membership database. If it is confirmed that the vehicle belongs to a member in good standing, the vehicle location is compared to a database of parking rules and restrictions at step 110. The server takes into account time and location of vehicle, then matches this data against the server's database of parking rules and restrictions. At step 111, the server also takes into account any special parking permits or exemption permits the vehicle owner may possess. From that information, the community server verifies whether or not the vehicle is illegally parked. If the vehicle is confirmed to be parked illegally, the server then obtains the member's contact information from the membership database. This may be the member's cell phone number and/or the member's email address. An alert message is then sent to the member at step 112. The alert message may be a single instance or combination of a text message, automated voice announcement or a unique audible tone generated from the wireless device via a dedicated software on the driver's wireless device, e.g., an app that the informant has downloaded. If exact vehicle location cannot be determined from the information received, the community server can still send out a warning to the driver but with a qualifying statement that the message is being issued solely based on an informant's tip. Upon receipt of a warning message, the member has the opportunity to move the vehicle before it is ticketed.

An option may be provided to the informant to manually call into the central server utilizing voice recognition. Through a series of tele-prompts the informant verbally states the vehicle's identification number (i.e. license plate number) and the location of the parked vehicle. The system converts voice data to text and the parking location data is then calculated and compared to the parking restrictions database as explained above. This back-up or secondary process is important for situations in which the informant does not have a GPS-enabled wireless device or otherwise when GPS location data cannot be obtained.

As mentioned above, members may be assessed a fee for warning messages at step 114. Fees collected in this manner may be used to support the community. A portion of each fee collected may be paid to the informant who reported the illegally parked vehicle. This encourages participation in the community. Reporting fees may even be paid to non-member informants to broaden the reach of the community. Although the issuance of fees for warning messages penalizes the driver for violating parking codes, the fine amount is expected to be significantly less than the original amount imposed by the city. This “penalizing” feature motivates drivers to remain conscientious in abiding by all parking rules and regulations.

The system may incorporate safeguards to prevent members from unfairly taking advantage of the parking alert service. For instance, if a registered member has received several alerts regarding parking infractions and is delinquent in making payments for those alerts, the system can place a tag or hold on that particular account. Any future detections of a parking infraction by the system of the member's vehicle will result in a temporary suspension of any further alerts being sent to the member until such time as the member's account is brought to current paid status.

Another safeguard that the community server may implement is designed to prevent member informants from falsely sending alerts to the system. Because member informants are financially rewarded for identifying illegally parked vehicles, it is expected that a certain number of members may attempt to take advantage of the system by falsely sending reports to the community server of illegally parked vehicles. For this reason, every member will have the right to contest the validity of any alert received. And because all reporting and alert activity is logged and recorded into the system, the community server will be able to identify and suspend account privileges of members who have submitted multiple alerts that have been subsequently contested by members.

There may be cases when a reported parking violation cannot be verified when comparing the vehicle location to the database of rules and restrictions. This may be due either to an error on the part of the informant or to erroneous information in the database. In such a situation, a warning message may nevertheless still be sent to the member, but with a qualifying statement that the message is being issued solely based on an informant's tip.

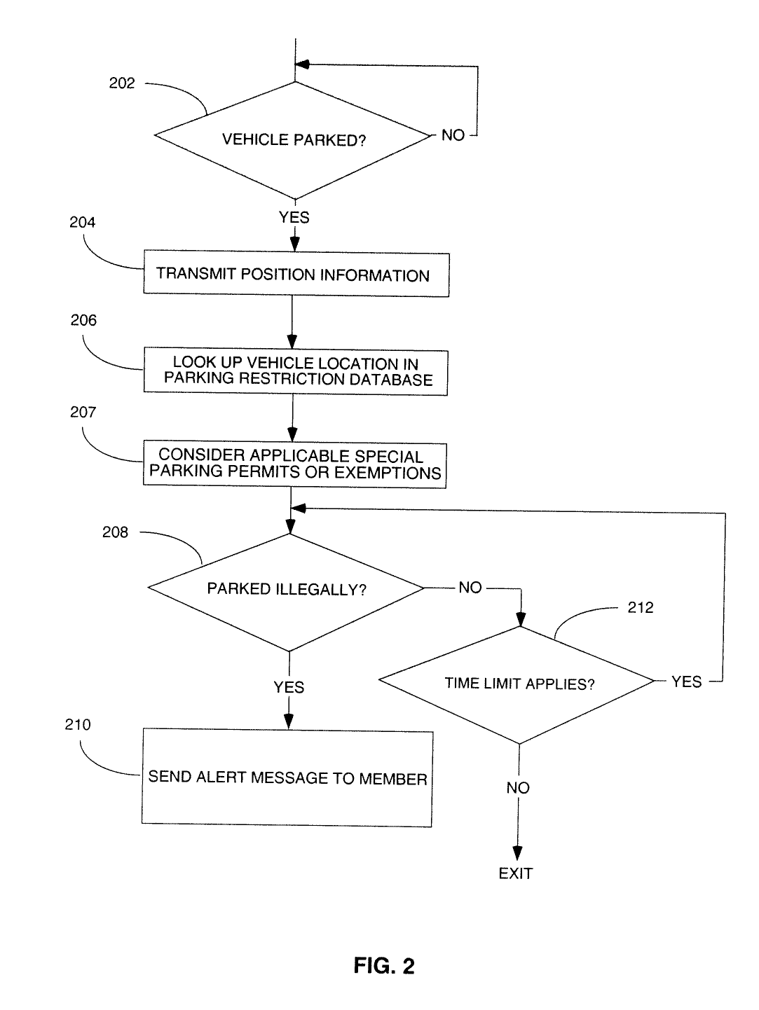

FIG. 2 is a flow diagram of another embodiment of the present invention. In this embodiment, as in the previously described embodiment, drivers register with an organization in order to receive parking alerts; however, this embodiment does not utilize human informants. Instead, this embodiment functions autonomously using the member driver's GPS-enabled wireless device or, in a variation, using the GPS functionality built into the vehicle. The fee arrangements and safeguards may be the same as in the previously described embodiment, although the fees and safeguards related to informants would not apply.

At step 202, the vehicle is monitored to determine if it has been parked. This is accomplished by monitoring a wireless connection, such as a Bluetooth™ or WiFi, between the vehicle's built-in hands-free equipment and the driver's cellular telephone or other communication device. An active connection indicates that the vehicle is in operation and not in a parked or powered off state. A Bluetooth™ or WiFi connection is broken when the vehicle's ignition is turned to the off position or when the driver has walked away from his vehicle and has exceeded the maximum range for connectivity (approximately 30 ft in the case of Bluetooth™). The broken wireless connection is therefore a useful indication of the status of the vehicle. If the vehicle is equipped with a communication system such as On-Star™, the vehicle can self determine when it is in a parked state, independent of a connection with a wireless device.

Once the vehicle is confirmed to be in a parked condition, vehicle position information acquired from either the driver's GPS-enabled wireless device or on board GPS is automatically transmitted to a central server via the driver's wireless device or the vehicle's communication system (such as On-Star™) at step 204. As in the previously described embodiment, communication with the server may be established with dedicated software on the driver's wireless device, e.g., an app that the driver has downloaded or directly through the vehicle communication system.

When the driver's vehicle is not equipped with an onboard communication system or other technology such as Bluetooth™ or WiFi, it is possible for the server to ascertain the parked status of a vehicle by acquiring information solely from the GPS enabled wireless device. This can be accomplished by monitoring and analyzing the topographical movement patterns and activity of the driver's GPS enabled wireless device. Because the patterns of vehicle movement differ from those of human movement, a multitude of indicators in combination can help the server determine the parked state of a driver's vehicle. For example, one indicator is speed. Average human walking speed is approximately 3 mph versus a vehicle's speed which ranges from 0-100 mph. Therefore, the GPS enabled wireless device in most cases can safely assume the vehicle is not in a parked state if it detects GPS movements greater than 3 mph. A second indicator is the detection of a vehicle coming to a parked state. The general pattern that takes place when a vehicle comes to a parked state is that it first slows down from a speed greater than 3 mph, then comes to a halt and remains in a stopped state for an extended period of time. This indicator alone, however, is not sufficient to absolutely determine that the vehicle is in a parked state because the same movement pattern occurs when a vehicle comes to a stop at a long signal light, and therefore, it may be possible to misinterpret the vehicle as being parked. Further information is needed. The distinguishing variable between the two instances occurs moments later. If the vehicle has only stopped because of a long signal light, GPS movements faster than 3 mph will soon be detected once the vehicle returns to a moving state. Conversely, if the vehicle has actually stopped to park, then subsequent GPS movements from the motorist's wireless device will likely simulate human walking patterns as the driver leaves his parked vehicle. For example, assuming the motorist is now moving by foot after he has parked his vehicle, the wireless device's GPS movements will likely not exceed 3 mph. Additionally, the “stop and go” patterns of human walking are distinct enough to be distinguished from vehicle movement. Finally, the geographic points of travel in human walking are different than those of vehicles. The likelihood of a motorist walking along a six lane freeway is extremely unlikely, as are the chances of a vehicle strolling through a shopping mall or office building. Therefore, by analyzing the various indicators and characteristics of GPS movement, the server can with a relatively high degree of accuracy determine the parked state of a vehicle.

Finally, another method of determining a vehicle's parked state in the event it is not equipped with Bluetooth™, WiFi or an onboard communication system is to create an alternative connection between the vehicle and the driver's mobile device. This can be done by docking the wireless device to a docking station connected to the vehicle. The docking station could be one of many types, such as a charging station or a music player docking station where music from the wireless device is played through the vehicle's stereo system. Whatever type of docking station is used, the main objective of the dock is to communicate to the wireless device that it is connected to the vehicle, and therefore inside the vehicle. A disconnection of the wireless device from the vehicle docking station serves as indication to the wireless device that the vehicle is now in a parked state.

Once the vehicle is confirmed to be in a parked condition, position information from the member driver's GPS-enabled wireless device is automatically transmitted to a central server at step 204. As in the previously described embodiment, communication with the server may be established with dedicated software on the driver's wireless device, e.g., an app that the informant has downloaded. Alternatively, such as when the driver's vehicle is not Bluetooth™ equipped, the driver may manually initiate a transmission to the central server upon parking his vehicle. This, of course, would require the driver to remember to initiate the transmission whenever the vehicle is parked or at least when the driver is uncertain about the applicable parking restrictions. As in the previously described embodiment, a back-up or secondary process may be provided for situations in which the driver does not have a GPS-enabled wireless device or otherwise when GPS location data cannot be obtained. In such case, the driver may manually call into the central server and, through voice recognition, verbally state the location of the parked vehicle.

It should be noted that GPS location data need be transmitted only once to the central server—at the time the vehicle is determined to be in a parked and stopped state. This is in direct contrast to the system disclosed in the Kim patent cited above, wherein the vehicle controller continuously monitors GPS location by constantly sending vehicle coordinates to the server, which then compares that data against the parking restrictions database. This constant transmission of data is not only unnecessary but places significant battery drain on the driver's mobile wireless device.

When position information is provided by a GPS system installed in the vehicle or on the driver's wireless device, a chronological series of GPS coordinates is sent to the central server instead of just a single set of GPS coordinates. This series of GPS coordinates provides the central server crucial information about the direction of travel and orientation of the vehicle. Thus, when the vehicle is finally determined to be in a parked condition, the vehicle's path of travel establishes the orientation of the vehicle and hence the server can deduce which side of the street the vehicle is parked on.

Regardless of how the vehicle position information is obtained by the central server, it is compared to a database of parking rules and restrictions at step 206. As in the previous embodiment, information regarding any special parking permits or exemption permits the driver may have on file are also taken into consideration at step 207. If this comparison reveals that the vehicle has been parked illegally (step 208), a warning message is sent to the driver's communication device at step 210. As in the previously described embodiment, the alert message may be a single instance or combination of a text message, automated voice announcement or a unique and identifiable audible tone generated from the wireless device via a dedicated software on the driver's wireless device, e.g., an app that the informant has downloaded.

There are many situations in which a vehicle is parked legally, but subsequently falls into violation with a parking rule or restriction. For example, on a Monday at 10:00 AM, a driver may park his vehicle in a location where parking is permitted at all times except for Mondays between 11:00 AM and 2:00 PM because of street cleaning. Although the driver initially parks his vehicle in a permitted zone, that same location changes to “NO PARKING” at 11:00 AM on the same day. The system disclosed in the Kim patent does not cover this occurrence. The “Timer” component of Kim's invention is only designed to determine whether or not the vehicle is parked or simply stopped. In contrast, the process illustrated in FIG. 2 records and logs the day and time when the vehicle has parked and assumes the vehicle remains in a parked state until a communication connection between the vehicle and wireless device is re-established or when the vehicle communication system (such as On-Star™) re-establishes connection with the server once the motor as been re-ignited. Step 212 determines if a time limit applies to the location at which the vehicle is parked. If the vehicle remains in a parked state beyond the time when parking is allowed (such as entering the no parking period between 11:00 AM and 2:00 PM), an alert is automatically sent to the driver at or somewhat before the time that parking is no longer permitted. The same applies when the driver parks in a location where parking is permitted only for a designated length of time.

A key feature of this invention which clearly distinguishes it from the Kim patent is that the system is designed to provide important information to the driver regarding parking restrictions for a specific location. Many parking locations are subject to various time length restrictions as well as “no parking” periods. A driver's decision to park his vehicle in a certain location is significantly influenced by any impending infractions. At the moment the vehicle is parked, the server, after receiving vehicle GPS coordinates, immediately queries the parking restrictions database and sends the driver information about how long he may park there and advises him of any impending “no parking” periods for that location. This is critical information the driver needs before he chooses to park in a certain location.

Because this service is provided via customizable software installed on the driver's mobile device or in the vehicle's communication system, the server is able to provide any level of information detail as instructed by the user. For example, the driver may only want to be notified upon an infraction having taken place. Or, before an infraction takes place, he may wish to set warnings and reminders to be sent 30 minutes prior instead of five minutes.

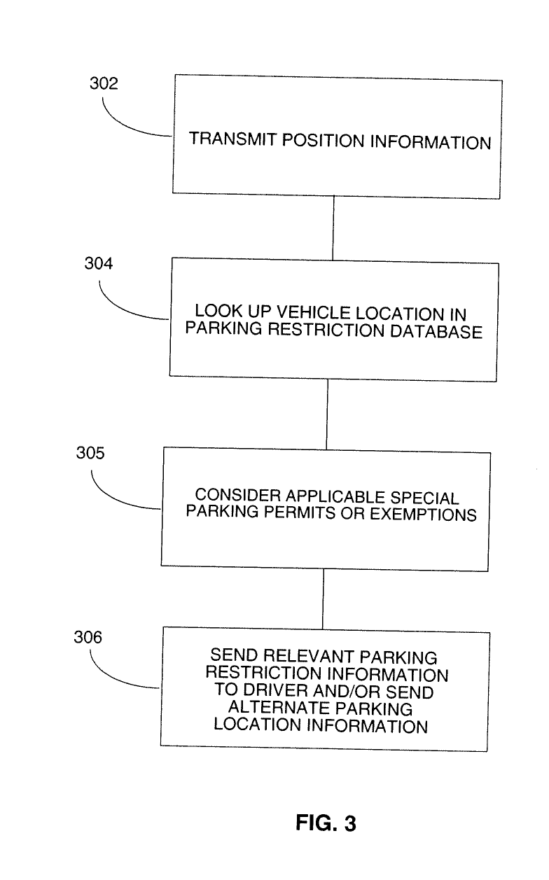

Still another embodiment of the present invention is illustrated in FIG. 3. This particular embodiment is directed more to addressing the confusion drivers experience when reading and trying to understand multiple parking restrictions. As in the previously described embodiment, the server is designed to provide the driver with useful information to help the driver avoid committing a parking infraction, rather than providing a warning to the driver after an infraction has already occurred. Because many parking signs are posted with multiple restrictions that apply to different days of the week, drivers often find it very confusing and difficult to interpret those regulations and to know if they are allowed to park there and, if so, for how long. The proposed service is designed to pare back all unnecessary parking restriction information that is inapplicable to a vehicle's location for that day and time. An example would be a driver parking in a location on a Monday at 8:00 am. The following parking signs are posted and read “A) 2 Hour Parking Monday thru Friday 8:00 am to 6:00 pm. B) No Parking Tuesdays 10:00 am to 1:00 pm for street cleaning. C) No Parking 12:00 am to 6:00 am daily. D) No Parking at any time Saturday and Sunday except by permit.” By removing all inapplicable parking restrictions and only stating relevant parking restrictions for that day and time, the proposed information service effectively addresses and solves the confusion drivers experience when reading and deciphering multiple parking regulations, many of which are inapplicable for the specific time period during which the driver is parking his vehicle. The information provided to the driver is delivered in a simple and understandable format, such as “You may park here for two hours.” In contrast to the Kim patent, which only identifies vehicles that have already violated a parking code, the present invention provides drivers with relevant parking rules and regulations for a specific location prior to a violation occurring, thereby giving the driver the information needed to decide whether or not to park in that location.

The position information of a vehicle is sent to a central server at step 302. By way of a custom software application installed either in the vehicle's onboard communication system or on the driver's mobile device, this may be done automatically upon sensing a parked condition, or communication with the server may be manually initiated by the driver at the time he has parked his vehicle or while he is slowly driving in search for a parking spot. As in the previous embodiment, specific information about the vehicle's street side location and orientation may be provided by using a compass function on the driver's device or retrieving a chronological series of GPS coordinates as described above.

Based on the position information, the server retrieves the parking rules and restrictions for the specific location at which the vehicle is parked (step 304). As in the previous embodiments, information regarding any special parking permits or exemption permits the driver may have on file are also taken into consideration at step 305. The relevant rules and restrictions are then sent to the driver's communication device at step 306 in an easily understandable format. These may be transmitted using a synthesized human voice in order to provide the information to the driver in as simple a format as possible. Information may also be transmitted by text message. It is preferred that only the relevant parking rules and restrictions for that specific day and time are sent to the driver and that all other irrelevant rules and restrictions be filtered out to prevent the same type of confusion that results from trying to read complicated restrictions on a posted sign. Again, the level of information detail can be customized by the user. For example, if a driver intends to park and keep his vehicle at a specific location for a considerably long time such as for the next three days, he will need to know applicable parking restrictions for the next 72 hours and thus instruct the server accordingly. The message transmitted to the driver can be very specific to the particular circumstances rather than providing a complete summary of the restrictions. For example, a message might state: “You can park at this location for two hours and 37 minutes” or “You can park at this location for four hours, but if you have permit number 584, you can park at this location all day.” If this service is membership based, the server can further simplify the message to the driver by internally taking into account any special parking permits or exemptions the driver may have on file and transmit an even more simplified message such as: “You may park here all day because you have permit number 584. Be sure to display your permit properly.” By filtering out unnecessary information and providing only relevant rules and restrictions in a clear and concise manner, the driver not only has the information to know whether or not he is parked legally but also understands how long he is allowed to park there.

Another key feature of the invention is that the server may also send the driver information concerning the availability of alternative parking locations within the driver's vicinity. This may be very useful for a driver who cannot find any available parking spots in the vicinity and needs to identify available alternative parking. The central server may interact with surrounding public parking lots in real time. In this regard, many public parking lots utilize modern technology to help identify the number of available parking stalls. They often go so far as to electronically display the number of available parking stalls on a lighted display at the entrance of the lot. By polling surrounding parking lots, the server can provide the driver with real time information, thus saving the driver time, fuel and frustration over possibly driving to a nearby parking lot only to find out that it is completely full. The message sent to a driver in such a situation may state, for example: “There are currently 53 open parking spots available in 0.2 miles at 1539 Main Street.”

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A method for issuing a parking violation warning comprising:
receiving a report of a vehicle suspected to be illegally parked, the report including vehicle identification information;
retrieving member contact information from a membership database based on the vehicle identification information;
sending a warning message to a member in accordance with the member contact information.

2. The method of claim 1 wherein the report further includes vehicle location information, the method further comprising retrieving applicable parking restrictions from a parking restrictions database based on the vehicle location information and, prior to sending the warning message, determining whether or not the vehicle is parked in violation of the applicable parking restrictions.

3. The method of claim 2 wherein the vehicle location information includes vehicle orientation information.

4. The method in claim 2 wherein the vehicle location information includes one of a geo-tagged photograph of the vehicle and a non-geo-tagged photograph of the vehicle.

5. The method of claim 2 wherein the step of determining whether or not the vehicle is parked in violation of the applicable parking restrictions includes consideration of applicable special parking permits or exemptions.

6. The method of claim 1 wherein the report is received from an informant unrelated to both the parked vehicle and the member.

7. The method of claim 1 wherein the warning message comprises at least one of a voice message, a text message, an email message and a unique audible tone.

8. A method for issuing a parking violation warning comprising:
transmitting location information from one of (i) a vehicle navigation system and (ii) a portable communication device carried by a driver of a vehicle;
monitoring a parking status indicator of the vehicle to determine that the vehicle is in a parked condition, the parking status indicator comprising one of (i) a status of a connection between the vehicle and a portable communication device carried by a driver of the vehicle and (ii) analysis of the location information over time;
receiving the location information and retrieving applicable parking restrictions from a parking restriction database based on the location information once the vehicle is determined to be in the parked condition;
determining whether or not the vehicle is parked in violation of the applicable parking restrictions;
sending a warning message to the driver of the vehicle if the vehicle is determined to be parked in violation of the applicable parking restrictions.

9. The method of claim 8 wherein the warning message comprises at least one of a voice message, a text message, an email message and a unique audible tone.

10. The method of claim 8 wherein the location information includes vehicle orientation information.

11. The method of claim 8 wherein the step of determining whether or not the vehicle is parked in violation of the applicable parking restrictions includes consideration of applicable special parking permits or exemptions.

12. The method of claim 8 further comprising determining a side of a street on which the vehicle is parked based on an analysis of the location information over time.

13. A method for providing parking restriction information comprising:
receiving information designating a vehicle location;
retrieving applicable parking restrictions from a parking restriction database based on the vehicle location information;
comparing the applicable parking restrictions to a current day and time;
sending a message to a driver of the vehicle indicating whether or not the vehicle may be parked at the designated location in compliance with the applicable parking restrictions.

14. The method of claim 13 wherein the message comprises at least one of a voice message, a text message, an email message and a unique audible tone.

15. The method of claim 13 wherein the message includes information about alternate parking locations.

16. The method of claim 13 wherein the message includes a length of time that the vehicle may be legally parked at the designated location.

17. The method of claim 13 wherein the vehicle location information includes vehicle orientation information.

18. The method of claim 13 wherein the message to the driver of the vehicle further indicates whether or not the vehicle may be parked at the designated location in compliance with applicable special parking permits or exemptions.

19. The method of claim 13 wherein the vehicle location information is transmitted from a portable communication device carried by a driver of the vehicle.

20. The method of claim 19 wherein the portable communication device includes application software for automatically transmitting vehicle location information.
